(19) United States
(12) Patent Application Publication
(10) Pub. No.: US 2016/0371783 A1
(43) Pub. Date: Dec. 22, 2016

(54) INTEGRATED INSURANCE PRODUCT QUOTE SYSTEM AND METHOD

(71) Applicant: Humana Inc., Louisville, KY (US)

(72) Inventor: Ulrich Lohrmann, Downers Grove, IL (US)

(73) Assignee: Humana Inc., Louisville, KY (US)

(21) Appl. No.: 14/210,594

(22) Filed: Mar. 14, 2014

Related U.S. Application Data
(60) Provisional application No. 61/785,870, filed on Mar. 14, 2013.

(51) Int. Cl. G06Q 40/00

(52) U.S. Cl. CPC G06Q 40/08

(57) ABSTRACT

An integrated quote system and method for generating quotes for multiple insurance products is disclosed. Quotes for multiple insurance products are integrated into a single, easy-to-read document. In an example embodiment, an agent enters a client's personal data into a quoting tool of an agent's workbench application. The client's data is automatically applied to every insurance product or plan the agent quotes for the client or client's family. Each quoted product is assigned a quote reference number and quotes for multiple products are linked using a quote identifier. A “recalculate” option updates any relevant calculations allowing the agent to review relevant financial details before generating a final quote. Products categories may be expanded or minimized as the agent navigates through insurance offerings so that only relevant information is displayed. Additional features and functionality support an online application process for each quoted product.

### CROSS-REFERENCE TO RELATED APPLICATIONS

This application claims priority to U.S. Provisional Application Ser. 61/785,870, filed Mar. 14, 2013 and titled INTEGRATED INSURANCE PRODUCT QUOTE SYSTEM AND METHOD, the contents of which is incorporated herein by reference.

### BACKGROUND OF THE INVENTION

When researching insurance products, many consumers are interested in learning whether they will qualify for discounts by purchasing more than one product from an insurance company. In some instances, a consumer may want or need coverage that is available only under multiple products or plans. For example, in the health insurance industry, medical, dental, vision, and life insurance is typically offered through separate policies underwritten by a single insurance company. Coverage for all areas, therefore, requires the purchase of multiple products. In other instances, a consumer may be willing to cancel one or more existing policies with one or more insurers and enter into new policies with a new insurer in order to receive better rates or discounts under a multi-policy program. Regardless of the motivation, when contacting insurers, consumers are often interested in learning about all of the products and services each insurer offers as well as the costs and applicable discounts.

In the health insurance industry, insurance premiums for different types of insurance products depend on a number of factors. For example, medical insurance premiums are typically based on details such as the insured's age, sex, location, and whether the insured has dependents that will be covered under the policy. Deductible and co-insurance options may vary as well. Quotes are personalized based on numerous factors and therefore, can be time consuming for agents of insurance companies to generate. Insurance agents typically collect the relevant data from the prospective insured and enter it in a computerized insurance underwriting application that generates a quote based on the prospective insured's personal data, deductibles, etc. Although underwriting applications facilitate the process of generating quotes, they are typically “policy-specific” and therefore, capable of generating quotes for only one type of policy. If a prospective insured is interested in more than one type of policy, the agent typically must re-enter the same data in different underwriting applications and generate each quote separately. Because separate applications are used to generate each quote, the layout and presentation of relevant information for each quote may be different, even though the quote is from the same insurer. The consumer, therefore, may have difficulty in finding and reviewing relevant details in each quote and understanding the complete package offered by the insurer.

There is a need for an application that generates an integrated quote for multiple insurance products. There is a need for an automated system and method that streamlines the quote process for multiple insurance products. There is a need for an integrated quote generation system and method that reduces data entry requirements and that generates quotes that are clear, concise, and easy for consumers to understand.

### SUMMARY OF THE INVENTION

The present disclosure is directed to an integrated quote system and method for generating quotes for multiple insurance products. Quotes for multiple insurance products are integrated into a single, easy-to-read document. In an example embodiment, an agent enters a client's personal data into a quoting tool of an agent's workbench application. The client's data is automatically applied to every insurance product or plan the agent quotes for the client or client's family. Each quoted product is assigned a quote reference number and quotes for multiple products are linked using a quote identifier. A “recalculate” option updates any relevant calculations allowing the agent to review relevant financial details before generating a final quote. Products categories may be expanded or minimized as the agent navigates through insurance offerings so that only relevant information is displayed. Additional features and functionality support an online application process for each quoted product.

The disclosed integrated quote system and method generates quotes that are easier for consumers to review and understand. The integrated quote system and method reduces data entry requirements and as a result, increases agent productivity.

### BRIEF DESCRIPTION OF THE DRAWINGS

FIG. 1 is a “quote generation” start page according to an example embodiment;

FIGS. 2A and 2B are “generate a quote” pages according to an example embodiment;

FIG. 3 is a product category page according to an example embodiment;

FIGS. 4A and 4B are “products selection” pages according to an example embodiment;

FIGS. 5A-5C are “stand-alone products” pages according to an example embodiment;

FIGS. 6A and 6B are “optional benefits details” pages according to an example embodiment;

FIG. 7A is a “save quote” page and FIG. 7B is a “send quote” page according to an example embodiment;

FIGS. 8A and 8B are “customer search” pages according to an example embodiment;

FIG. 9A is a “quotes” page according to an example embodiment;

FIGS. 9B and 9C are “applications” pages according to an example embodiment;

FIGS. 10A and 10B are “agent initiated applications” pages according to an example embodiment;

FIGS. 11A and 11B are online application pages according to an example embodiment;

FIGS. 12A and 12B are application checklist pages according to an example embodiment; and

FIGS. 13A-13C are sample quote pages according to an example embodiment.

### DETAILED DESCRIPTION

An integrated quote system and method supports generation of a single quote for multiple insurance products. An agent or other user interacting with the integrated quote application can quote multiple insurance products or plans at the same time. A quote identifier is used to link all products included in a single quote.

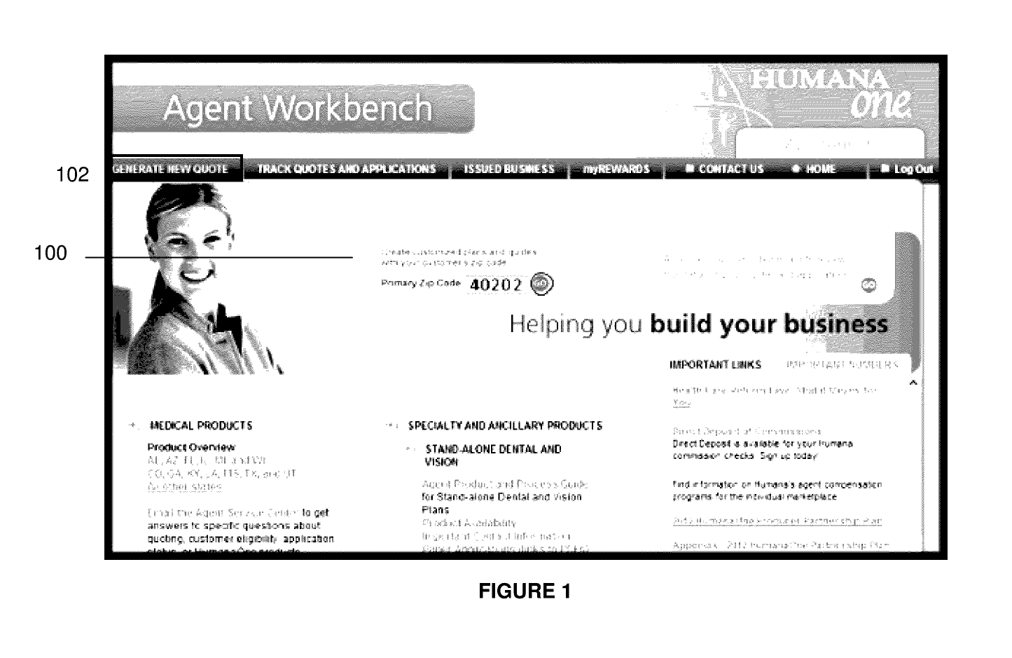

Referring to FIG. 1, a “quote generation” start page according to an example embodiment is shown. In an example embodiment, the quote generation process may begin with entry of a zip code in a number field and selection of a “go” option 100. Alternatively, a user may select a “generate a quote” option 102.

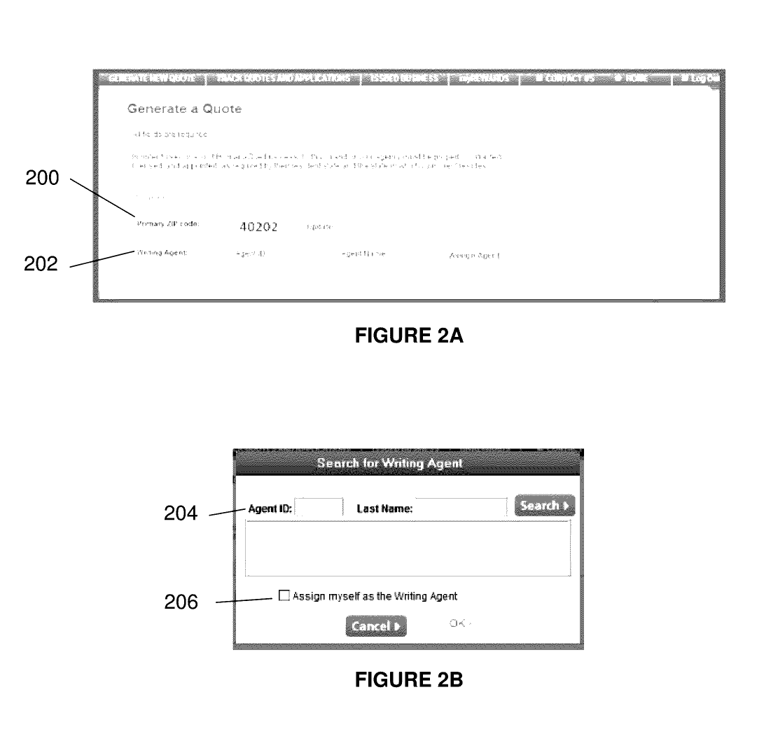

Referring to FIG. 2A-2B, “generate a quote” pages according to an example embodiment are shown. Referring to FIG. 2A, the user is prompted to enter an applicant's zip code 200. If a zip code was entered on the start page as shown in FIG. 1, this field may be auto-populated. The specification of a zip code allows further options in the application to be limited according the specified zip code. Because insurance is regulated by state, it is important that an agent quote only products sold in the applicant's state. Additionally, the user may be prompted to assign an agent to the quote 202. Referring to FIG. 2B, the agent may be identified by name or number 204 or the user may assign him or herself as the agent by selecting an “assign myself as the writing agent” option 206.

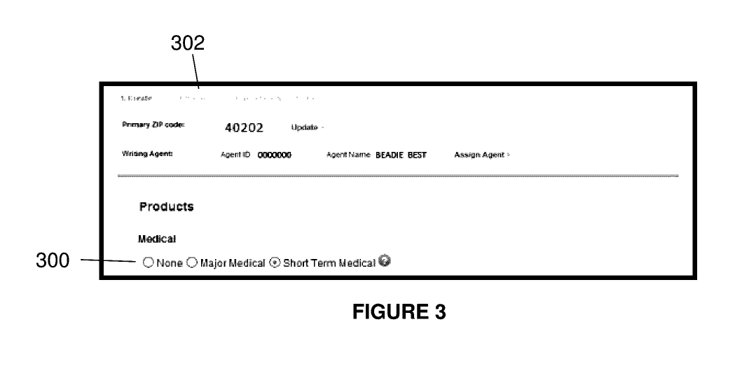

Referring to FIG. 3, a product category page according to an example embodiment is shown. In an example embodiment, the supported products are in the METHOD health insurance industry and include medical, dental, and vision products 300. The user may select one of the listed product categories to continue the quote generation process. The product categories are listed in Table 1.

TABLE 1
Product Options

| Category | Description |
|---|---|
| Major Medical | Individual Major Medical and optional benefits available in the specified zip code. |
| Short Term Medical | If available and depending on state requirements, maximum duration (e.g., six or |
| | 12 month) benefit. |
| None | Stand-alone dental, stand-alone vision and financial protection products available |
| | in the specified zip code. |

In an example embodiment, optional benefits under a major medical plan or short term medical plan include dental, vision, and financial protection products. Detailed information for each product as well as locations where specific products may be sold may be stored in one or more databases. As the user makes selections, data responsive the user's selections is retrieved from the databases and appropriate calculations are made based on the user's selections, applicant data, product plan data, etc.

Detailed information about products, their characteristics, availability, presentation, how and where they can be sold, legal restrictions, legal requirements, comparison points, rules for applicant eligibility, and enrollment data collection requirements are stored in database tables and documents. For example, to determine scope of possible products and available product combinations, all products are weighed against availability and eligibility rules. For example, the following items may be considered: location (state, zip code, county); business defined geographical areas (service areas); time (current date time, product effective date); marketing campaigns; workflows; and agent legal right to sell the product. Once the available products are determined, then additional product detail is available to group the products and provide additional aspect parameters that help describe, classify, and organize presentation. Sample product configuration tables are shown in Table 2.

TABLE 2
Sample Direct Product Configuration Tables

| Table Name | High Level Definition |
|---|---|
| Characteristics | Product Characteristic |
| AgentSeries | Agent Availability |
| AgentSeries_Agents | Agent Availability |
| Attributes | Product Attributes |
| AttrValueGroups | Product Attributes |
| AttrValues | Product Attributes |
| Availability | Availability Definitions |
| Campaigns | Marketing Campaign |
| Campaigns_InsProducts | Marketing Campaign |
| Campaigns_InsProducts_WorkFlowTypes | Marketing Campaign |
| Campaigns_InsProducts_WorkFlowTypes_States | Marketing Campaign |
| Campaigns_WorkFlows | Marketing Campaign |
| Conditions | Rule Definitions |
| ConditionValues | Rule Definitions |
| Counties | Geographic Definitions |
| DistributionChannelGroups | Partners |
| DistributionChannels (*for Prod to Prod bricks | Partners |
| only!) | |
| eGroups | Product Grouping |
| eGroups_InsProducts | Product Grouping |
| FixedListValues | General Definitions |
| Fulfillments | Fulfillment Properties |
| Fulfillments_InsProducts | Fulfillment Properties |
| Geographics | Geographic Definitions |
| GeographicsMultipleCities | Geographic Definitions |
| GeographicsMultipleCounties | Geographic Definitions |
| GeographicsMultiZipcodes | Geographic Definitions |
| InsProductBuildGroups | Product Detail |
| InsProductBuilds | Product Detail |
| InsProductClasses | Product Detail |
| InsProducts | Product Detail |
| InsProducts_CalcLocations | Product Detail |
| InsProducts_ComputationSeq | Product Detail |
| InsProducts_Fees | Product Detail |
| InsProducts_InsProductClasses | Product Detail |
| InsProducts_ModalFactors | Product Detail |
| InsProducts_PaymentOptions | Product Detail |
| LogicTags_Areas | Rule Definitions |
| PaymentRecurrentRates | Product Detail |
| RestrictionFilters | Rule Definitions |
| Rules | Rules Engine |
| Rules_Attributes | Rules Engine |
| Rules_InsProducts | Rules Engine |
| ServiceAreas_ZipCodes | Geographic Boundaries |
| ServicesAreas | Geographic Boundaries |
| ServicesAreas_Counties | Geographic Boundaries |
| States | States |
| Templates | Product Comparison |
| Templates_Characteristics | Product Comparison |
| TemsActions | Rules Engine - Rules/Action Definition Detail |
| TemsActionSets | Rules Engine - Rules/Action Definition Detail |
| TemsActionSets_TemsActions | Rules Engine - Rules/Action Definition Detail |
| TemsActionTypes | Rules Engine - Rules/Action Definition Detail |
| TemsConditionAttributes | Rules Engine - Rules/Action Definition Detail |
| TemsConditionAttributeValueLists | Rules Engine - Rules/Action Definition Detail |
| TemsConditionOperators | Rules Engine - Rules/Action Definition Detail |
| TemsConditionOperators | Rules Engine - Rules/Action Definition Detail |
| TemsConditionOperators_Postfix | Rules Engine - Rules/Action Definition Detail |
| TemsConditions | Rules Engine - Rules/Action Definition Detail |
| TemsConditionSets | Rules Engine - Rules/Action Definition Detail |
| TemsConditionSets_TemsConditions | Rules Engine - Rules/Action Definition Detail |
| TemsEvents | Rules Engine - Rules/Action Definition Detail |
| TemsEventsActionSets | Rules Engine - Rules/Action Definition Detail |
| TemsEventsConditionSets | Rules Engine - Rules/Action Definition Detail |
| TemsEventTypes | Rules Engine - Rules/Action Definition Detail |
| TemsRuleEngineExpressionLists | Rules Engine - Rules/Action Definition Detail |
| TemsRuleEngineExpressionListsDirect | Rules Engine - Rules/Action Definition Detail |
| TemsRules | Rules Engine - Rules/Action Definition Detail |
| TemsRules_TemsActions | Rules Engine - Rules/Action Definition Detail |
| TemsRules_TemsActionSets | Rules Engine - Rules/Action Definition Detail |
| TemsRules_TemsConditions | Rules Engine - Rules/Action Definition Detail |
| TemsRules_TemsConditionSets | Rules Engine - Rules/Action Definition Detail |
| TextTags | UI Reference Tags |
| Underwriters | Underwriting Classification |
| Workflows | Workflows |

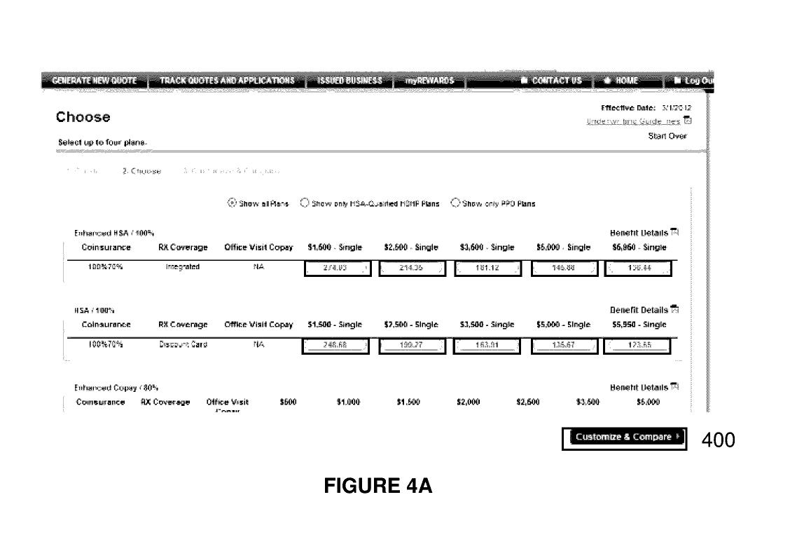

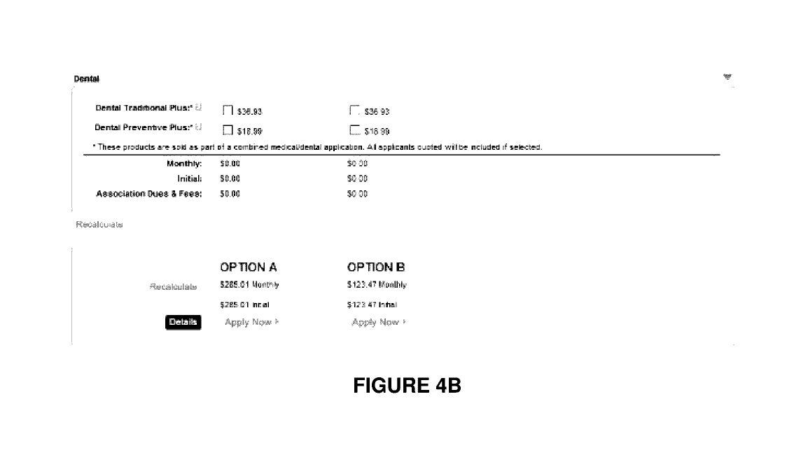

The user may view the products and plans for the selected product category by selecting the “choose” tab 302. FIGS. 4A and 4B are “products selection” pages according to an example embodiment. Referring to FIG. 4A, a “products list” page according to an example embodiment is shown. The products list page lists details for each product that meets the selection criteria. In an example embodiment, the user may select up to four products within the product category. If the selected product is a medical product, optional benefits may be added by selecting a “customize and compare” option 400. Referring to FIG. 4B, an “optional benefits” page according to an example embodiment is shown. The optional benefits that may be selected with a primary product are shown and user may select one or more optional benefits from the page.

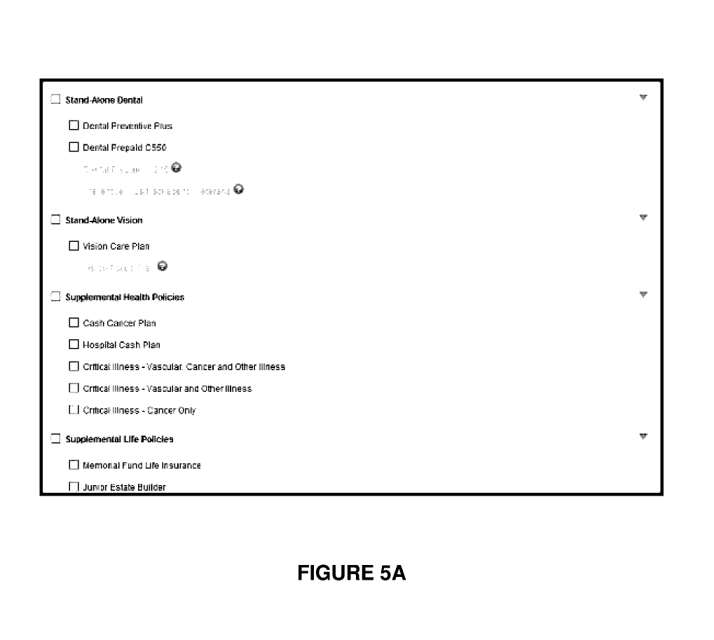

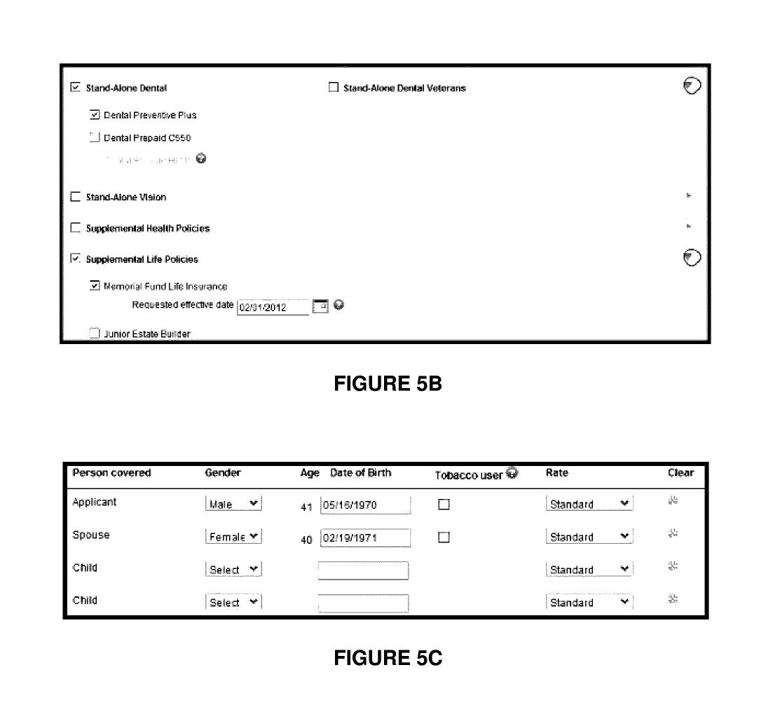

FIGS. 5A-5C are “stand-alone products” pages according to an example embodiment. Referring to FIG. 5A, a first “stand-alone products” page according to an example embodiment is shown. The pages provide functionality for combining products for a quote. A list of available products is displayed along with check boxes to permit the user to select one or more products. Products the agent is not certified to sell are “disabled” or “grayed” so the user cannot select them. In an alternative embodiment, the products may be excluded from the page that is generated. Selection of certain products (e.g., a supplemental life/memorial fund life insurance product) may result in prompts for additional information such as an effective date as illustrated in FIG. 5B.

Referring to FIG. 5C, a “prospects” page according to an example embodiment is shown. On the prospects page, the user is prompted to enter information about each individual that may be covered by the plan. To facilitate calculation of a quote for all products and persons included in the quote, the user is prompted to enter each person's date of birth. The date of birth is used to calculate an accurate quote due to the actuarial algorithms that apply to the various plans. Some plans calculate based on nearest age, not attained age, which requires logic to determine if the prospective insured is past his or her half birthday. These rules are applied simultaneously along with more traditional methods of rating based on attained age or age bands. There are also age eligibility rules that are applied and that require a more accurate representation of age than a year. Additional applicant data such as the applicant's name, contact information, occupation, etc. may be entered and stored in a database using other features and functionality of the application, using a separate application such as a contact management application.

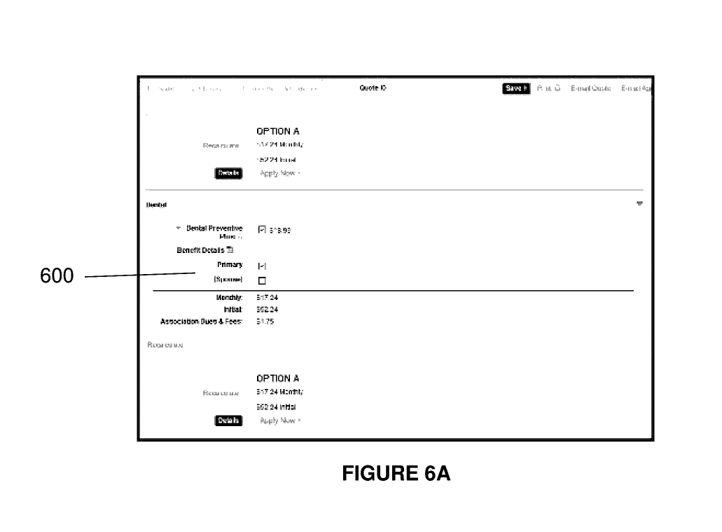

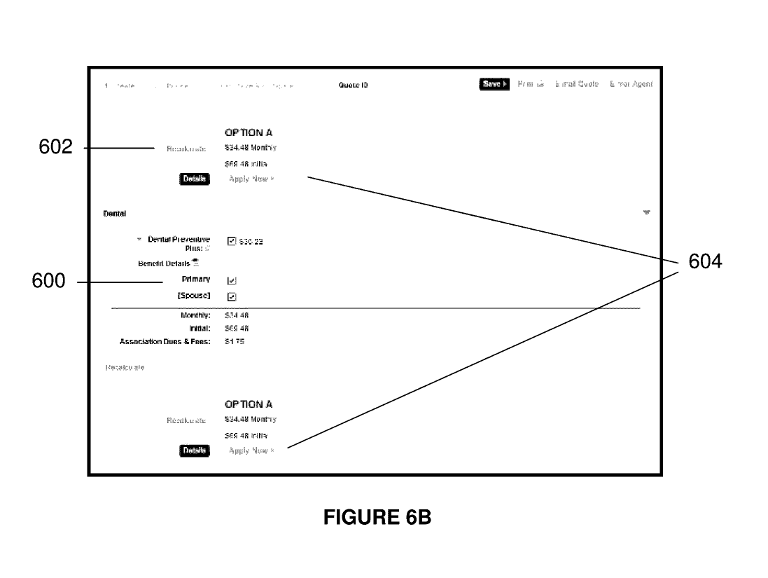

FIGS. 6A-6B are “optional benefits details” pages according to an example embodiment. Referring to FIG. 6A, a first “optional benefits details” page according to an example embodiment is shown. Details related to the selected optional benefits are presented. In addition, the user is prompted to specify which prospects should be included in the plan. Referring to FIG. 6B, a “prospects” page according to an example embodiment is shown. The user may change the prospects selections 600 and select a “recalculate” option 602. Payments, premiums, fees, etc. are recalculated and updated on the page based the addition or deletion of a prospect. Finally, the user may select an “Apply now” 604 option to initiate an application process.

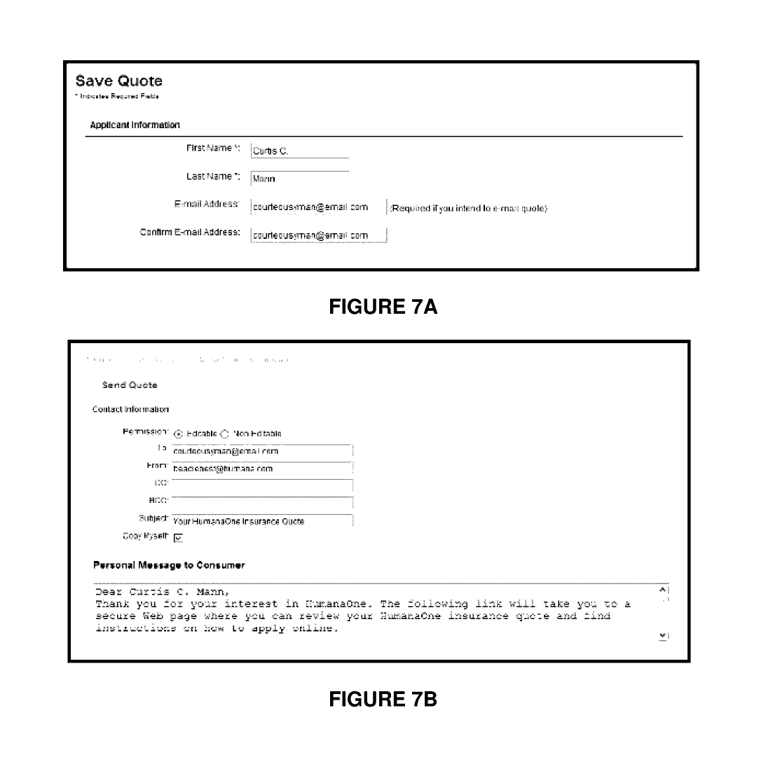

Referring to FIG. 7A, a “save a quote” page according to an example embodiment is shown. The user enters the applicant's name and an email address if the applicant is interested in receiving the quote by email. Referring to FIG. 7B, a “send quote” page according to an example embodiment is shown. The user may enter a personal message to send with the quote.

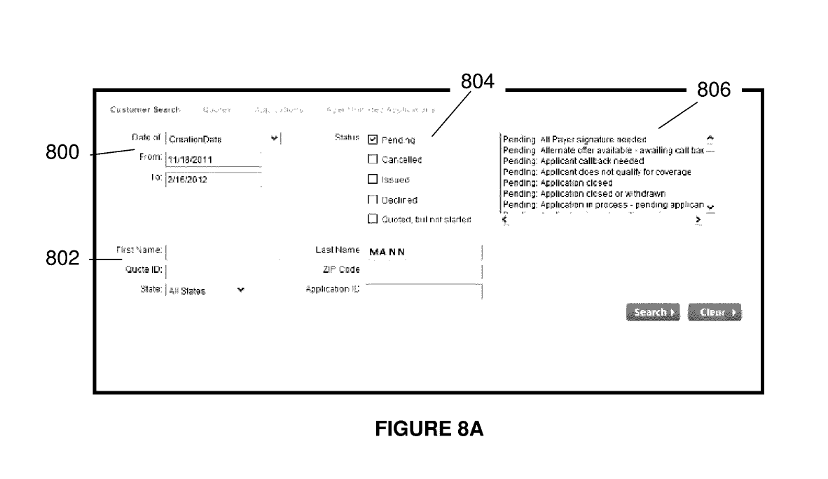

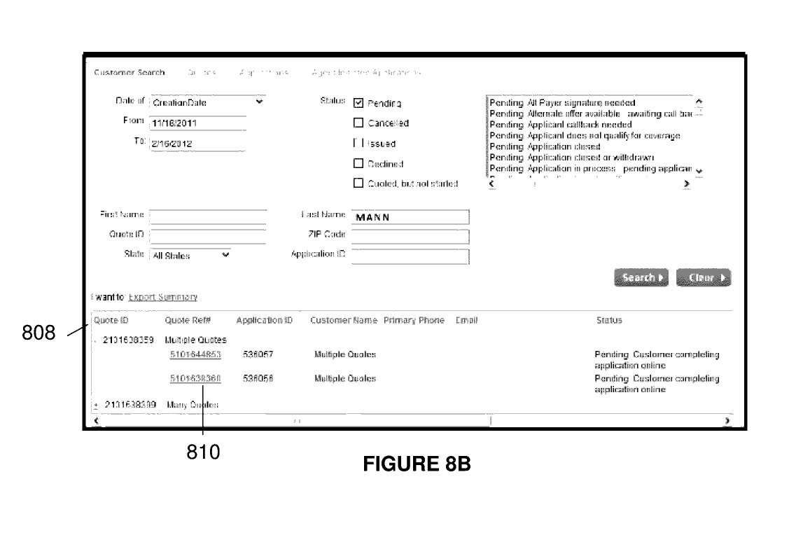

FIGS. 8A and 8B are “customer search” pages according to an example embodiment. Referring to FIG. 8A, a first “customer search” page according to an example embodiment is shown. In an example embodiment, the search criteria includes date data 800, quote identifying data (e.g., name, quote identifier, zip code, state, or application identifier) 802, and a status indicator 804. A sub-status indicator may be selected from a list 806. Referring to FIG. 8B, a search results page according to an example embodiment is shown. Quotes that match the search criteria are displayed and may be organized based on a quote identifier (“Quote ID”) 808. As indicated in FIG. 8B, quotes for different products may be linked to a single quote identifier. The user may view details for each quote by selecting a quote reference number (“Quote Ref#”) 810. There is a one-to-many relationship between the quote identifier and quote reference number as shown below.

Quote ID:
Quote Reference Number 1
Quote Reference Number 2
Quote Reference Number 3

Each quote reference number holds one plan (application), and the plans (applications) are grouped together by the Quote Identifier.

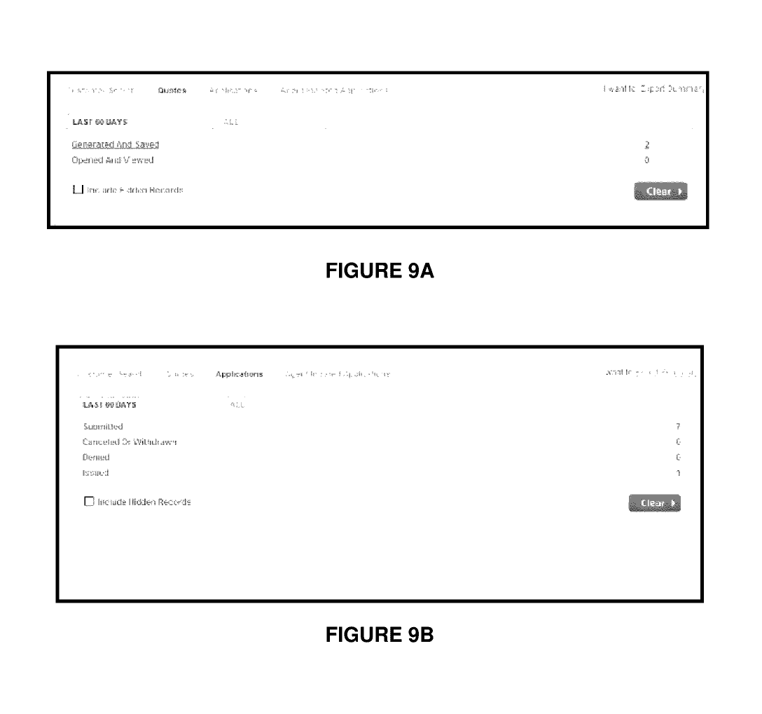

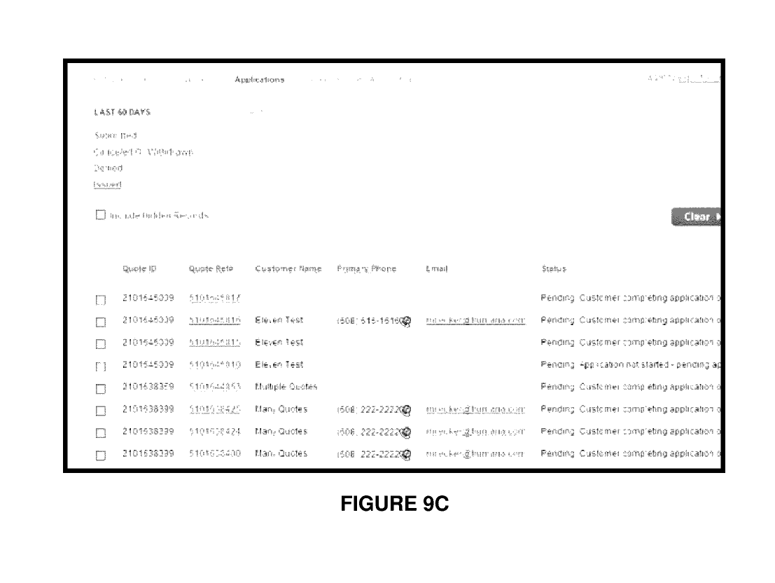

Referring to FIG. 9A, the user may select a “quotes” tab to view quotes that have been “generated and saved” or quotes that have been “opened and viewed.” FIGS. 9B and 9C are “applications” pages according to an example embodiment. Referring to FIG. 9B, the user may select an “applications” tab to view applications that have been submitted, canceled or withdrawn, denied, or issued. If the user selects the “submitted” option, a list of quote identifiers and related quote reference numbers is displayed as shown in FIG. 9C.

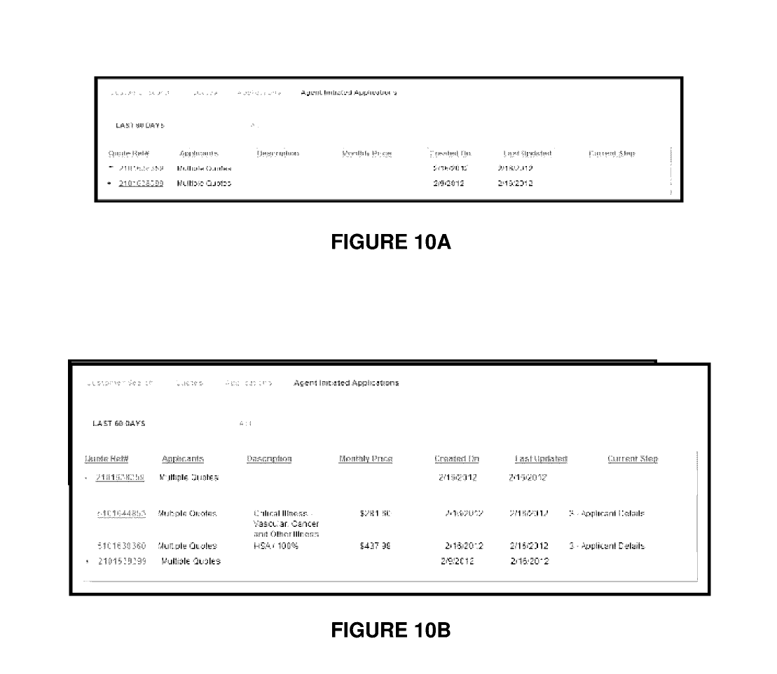

FIGS. 10A and 10B are “agent initiated applications” pages according to an example embodiment. Referring to FIG. 10A, a first “agent initiated application” page according to an example embodiment is shown. The page displays all of the quotes a specified agent has initiated. If the user selects the “+” symbol next to a quote identifier, all of the quotes associated with the quote identifier are listed as shown in FIG. 10B. For each quote, the quote reference number, applicant, product description, and other details are shown.

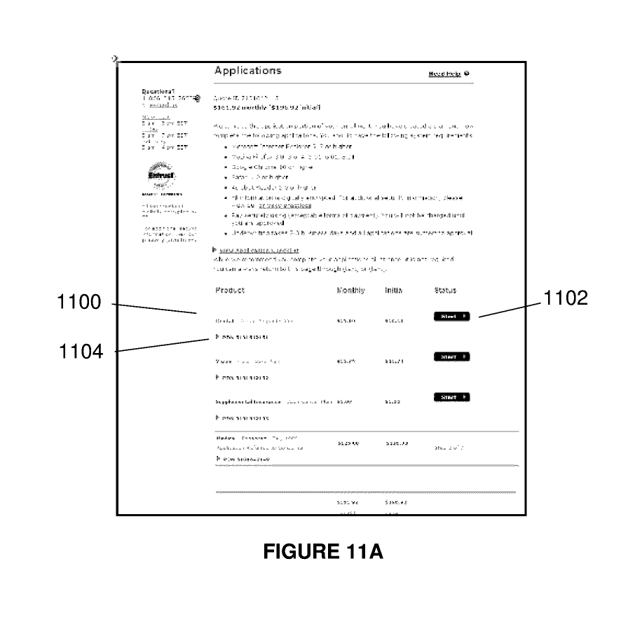

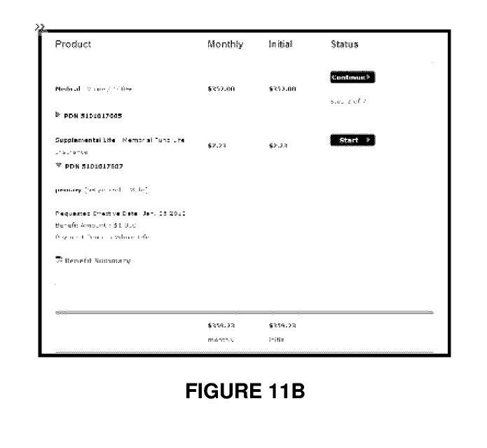

Referring to FIGS. 11A and 11B, online application pages according to an example embodiment are shown. The user may access the initial online application page by selecting a quote reference identifier from the list of agent initiated applications as shown in FIG. 10B. Alternatively, the user may select an “Apply now” 604 option as shown in FIG. 6B to initiate an application process.

For each product, the application page displays the product information, the monthly and initial payment and the status of the application 1100. The user is also presented with options to start or continue the application process 1102. The user may select a symbol by the quote reference number to view details for plan 1104. Referring to FIG. 11B, the plan details may include the individuals covered by the plan, their requested effective date, the deductibles or benefit amounts, and a link to a benefits summary for the product.

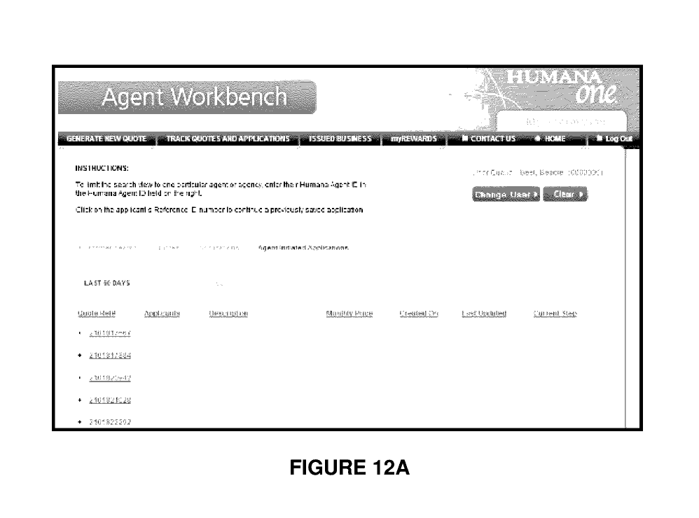

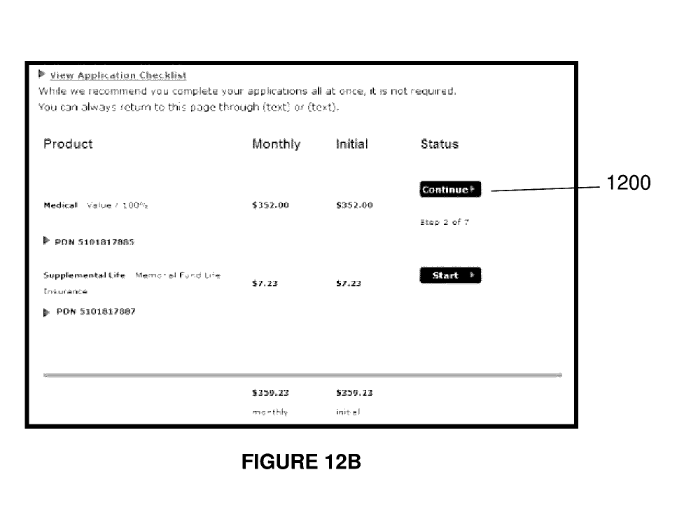

Referring to FIG. 12A, an “agent initiated application” page may be used to access application details. A list of selectable quote reference numbers may be displayed. The user may select a quote reference number to view an “application checklist” page as shown in FIG. 12B. The checklist page displays the product information and status information for the each quote including the applicable step in the application process 1200.

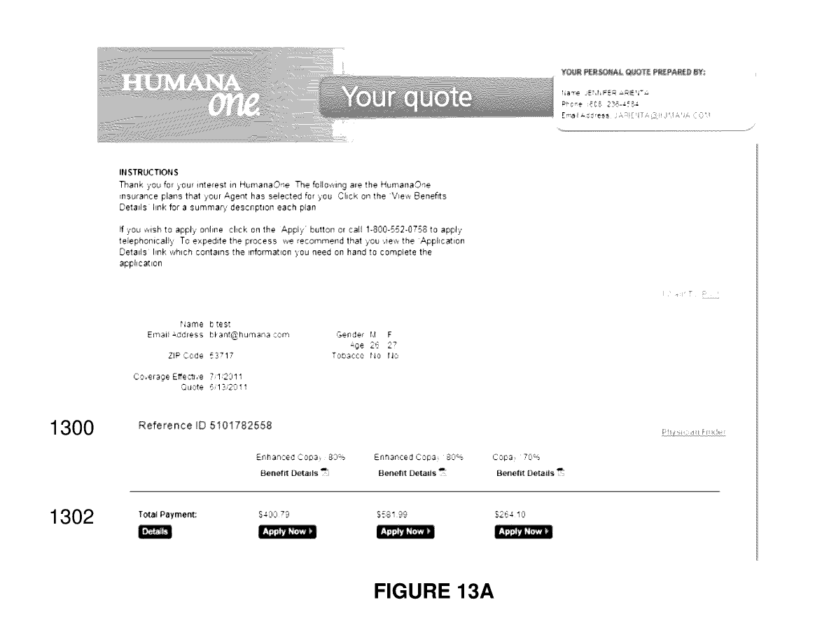

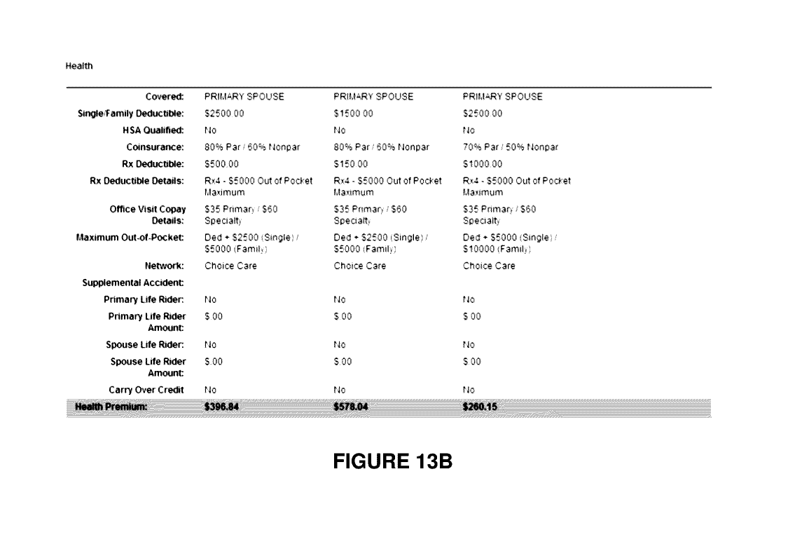

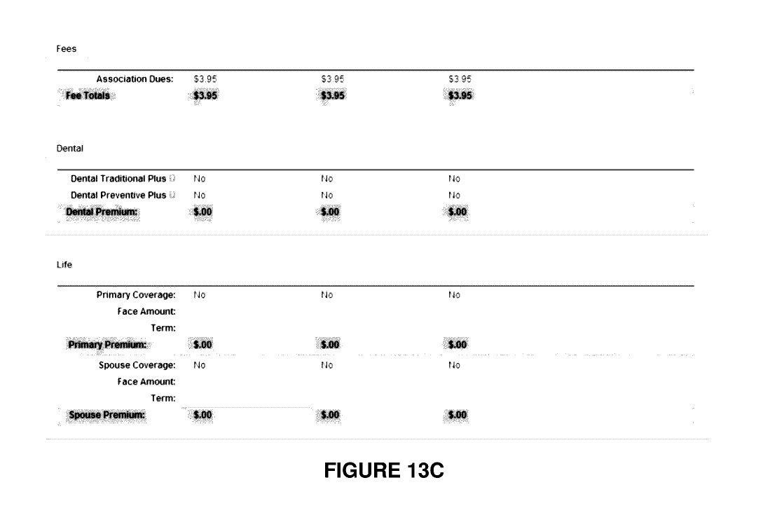

Referring to FIGS. 13A-13C, sample quote pages according to an example embodiment are shown. Referring to FIG. 13A, in an example embodiment, the quote comprises a quote identifier 1300 and a link to benefit details for each policy or plan that is quoted. The quote shows the total premium for each of the plan options. Referring to FIGS. 13B and 13C, benefit details applicable to each selected product and/or optional benefit categories are shown. The details allow the applicant to compare the product offerings with a single product category as well as between product categories.

To generate a quote, baseline information from the user (typically the target applicant for the quote and other individuals to be included in the quote (e.g., include the spouse and kids) and where he/she lives (state, zip, and county)) is provided to a quote generation process. Additional details may also be requested such as the ages of the applicants, the gender of the applicants, and perhaps contact related information such as email address or mailing address. Circumstance information may also be included such as identifying information for the selling agent and details regarding the current marketing campaign in process. Typically, the circumstance information determined or derived without user involvement based on who and how the quote request was initiated. For example, when an agent logs in to identify him- or herself, the quote application checks state licensing information to identify which products they are permitted to sell. That information is retained and used as additional input rules for the quote process to determine the products that are available for sale.

The above information serves as input into the quote generation process which determines which products are available for sale along with all price points for every related optional circumstance. If the volume of return information from the process is large, a reduced set of information is made available but with sufficient identifiers (e.g., product identifier, benefit identifier, campaign identifier, grouping identifiers) and details so that when the user requests additional information, it can be retrieved seamlessly and in real time. This information is made available with automated services (e.g., web service). For integrated presentation and distribution, the user interface format typically is made available on a website but may be applied off line as well.

With all the details from the quote generation process returned and presented in a user interface, the user requesting the quotes also has the ability to alter the baseline information for the respective quotes during presentation of the products of interest in an intuitive user interface thus enabling the ability to transition desired selections immediately all the while seeing real time updates in pricing based on selections for each product line.

At any point, the user can save the quote information for later retrieval by selecting a “save” option. When the save request is initiated, the system reviews the information the user has provided and builds a respective quote for each product the user has selected and then persists that information to a database for later retrieval (so the user can pick up where they left off). The saved quote can also be referenced in communications through a set of identifiers for each individual quote or collectively as a group.

To support working with quotes as a group, a grouping structure is also available and persisted to the database along with the individual quotes. This structure binds all the individual quotes together with the common unique quote identifier. The unique quote identifier allows the system to work with all the quotes together as a whole or treat each quote individually but allow the sharing of common information across the group of quotes. Once the quoting process has completed and enrollment begins, each individual quote is examined and a respective enrollment application is started. These new enrollment applications have their own unique identifier and are bound to the respective quote by reference. They are also added to the group so that all quotes and enrollment applications are bound together individually and collectively. As the quotes are bound together with the enrollment applications, enrollment applications can be constructed and completed at the same time. Common information within the group can be used on each individual enrollment application dramatically reducing data collection efforts for all the applications as a whole. Also, in the process of enrollment, collection information and information changes for the individual application and/or applicant can be applied and shared with other applications within the group as needed.

While certain embodiments of the disclosed integrated insurance product quote system and method are described in detail above, the scope of the invention is not to be considered limited by such disclosure, and modifications are possible without departing from the spirit of the invention as evidenced by the claims. For example, elements of the user interface and page layouts may be varied and fall within the scope of the claimed invention. Various aspects of user interactions and presentation of data may be varied and fall within the scope of the claimed invention. One skilled in the art would recognize that such modifications are possible without departing from the scope of the claimed invention.

What is claimed is:

1. A computerized method for generating an insurance product quote comprising one or more computers executing the programming instructions:
(a) generating a first product quote for a first insurance product based on applicant data and insurance product data;
(b) generating a second product quote for a second insurance product based on said applicant data and said insurance product data;
(c) linking said first insurance product quote and said second insurance product quote to a quote identifier;
(d) receiving from a user computer a user selection of said quote identifier; and
(e) in response to receiving said user selection of said quote identifier, generating for display at said user computer a screen display comprising said first product quote and said second product quote.

2. The computerized method of claim 1 wherein said first insurance product and said second insurance product are selected from the group consisting of medical insurance, dental insurance, vision insurance, and financial protection insurance.

3. The computerized method of claim 1 wherein said first product quote and said second product quote comprise a product description and a premium.

4. The computerized method of claim 1 wherein said applicant data comprises date of birth data.

5. The computerized method of claim 1 wherein said applicant data comprises data for a plurality of prospective insureds.

6. The computerized method of claim 1 wherein said first insurance product quote and said second insurance product quote comprise an option to complete an online application for said insurance product.

7. The computerized method of claim 6 further comprising generating for display at a user computer a screen comprising a status for said online application.

8. A computerized method for generating an insurance product quote comprising one or more computers executing the programming instructions:
(a) storing in at least one database insurance product data for a plurality of insurance products;
(b) receiving applicant data for a prospective insured;
(c) receiving a user selection for a first insurance product within a first insurance product category;
(d) receiving a user selection for a second insurance product within a second insurance product category;
(e) assigning a quote identifier to a quote for said first insurance product and said second insurance product;
(f) generating a first product quote for said first insurance product based on said applicant data and said insurance product data;
(g) assigning a first product quote reference to said first product quote;
(h) linking said first product quote reference to said quote identifier;
(i) generating a second product quote for said second insurance product based on said applicant data and said insurance product data;
(j) assigning a second product quote reference to said second product quote;
(k) linking said second product quote reference to said quote identifier;
(l) generating for display at a user computer a screen display comprising said quote identifier;
(m) receiving a user selection of said quote identifier; and
(n) in response to receiving said user selection of said quote identifier, generating for display at said user computer a screen display comprising said first product quote and said second product quote.

9. The computerized method of claim 8 wherein said first insurance product and said second insurance product are selected from the group consisting of medical insurance, dental insurance, vision insurance, and financial protection insurance.

10. The computerized method of claim 8 wherein said first product quote and said second product quote comprise a product description and a premium.

11. The computerized method of claim 8 wherein said applicant data comprises date of birth data.

12. The computerized method of claim 8 wherein said applicant data comprises data for a plurality of prospective insureds.

13. The computerized method of claim 8 wherein said first insurance product quote and said second insurance product quote comprise an option to complete an online application for said insurance product.

14. The computerized method of claim 13 further comprising generating for display at a user computer a screen comprising a status for said online application.

15. A computerized system for generating an insurance product quote comprising:
(a) at least one database storing:
(i) applicant data; and
(ii) insurance product data;
(b) at least one computer executing programming instructions to:
(i) generate a first product quote for a first insurance product based on said applicant data and said insurance product data;
(ii) generate a second product quote for a second insurance product based on said applicant data and said insurance product data;
(iii) link said first insurance product quote and said second insurance product quote to a quote identifier;
(iv) receive from a user computer a user selection of said quote identifier; and
(v) in response to receiving said user selection of said quote identifier, generate for display at said user computer a screen display comprising said first product quote and said second product quote.

16. The computerized system of claim 15 wherein said first insurance product and said second insurance product are selected from the group consisting of medical insurance, dental insurance, vision insurance, and financial protection insurance.

17. The computerized system of claim 15 wherein said first product quote and said second product quote comprise a product description and a premium.

18. The computerized system of claim 15 wherein said applicant data comprises date of birth data.

19. The computerized system of claim 15 wherein said applicant data comprises data for a plurality of prospective insureds.

20. The computerized system of claim 15 wherein said first insurance product quote and said second insurance product quote comprise an option to complete an online application for said insurance product.
